(19) United States
(12) Patent Application Publication
(10) Pub. No.: US 2006/0184077 A1
(43) Pub. Date: Aug. 17, 2006

(54) Method for operating a warm or hot air cabin and corresponding warm air cabin for carrying out said method

(76) Inventor: Paul Haslauer, Salzburg (AT)

Correspondence Address: LADAS & PARRY, 26 WEST 61ST STREET, NEW YORK, NY, 10023, US

(21) Appl. No.: 10/551,213

(22) PCT Filed: Mar. 23, 2004
(86) PCT No.: PCT/AT04/00107

§ 371 Date: Mar. 24, 2006

(30) Foreign Application Priority Data
Mar. 28, 2003 (AT) A 492/2003

(51) Int. Cl. A61H 1/00

(52) U.S. Cl. 601/15

(57) ABSTRACT

The invention relates to a warm air booth, as well as to a method for operating the same. In order to achieve particularly good treatment results, a cold medium, e.g. ice granules, snow or the like, is introduced during the warm, or hot air treatment, respectively, once or several times at time intervals into the booth (S) on the ceiling side thereof, and distributed in the treatment space through a rotor arranged on the ceiling side.

The invention relates to a method according to the preamble of claim 1.

A further object of the invention is a warm air booth for carrying out the method.

By warm air booths, a sauna, a steam bath, a Brechel bath or the like facilities are to be understood, in which dry and moist air or vapor are supplied to the human body. In such facilities, the bathing guest is subjected to a thermal stimulus, which is followed by cooling in cold air, water or snow. The essential disadvantage of these facilities is primarily the high costs of the energy consumed irrespective of the number of guests using them. A further disadvantage of these facilities has been that thermophysical resources have not, or have not sufficiently, been used, or that it has not been ensured that the use thereof occurred at the right time, associated with a lessening of the intended effect.

From EP 779 067, a warm air steam bath booth with a furnace arrangement has been known which sucks in fresh or ambient air and wherein the latter is made to circulate by means of a motor-driven fan or via a vapor generator. Although this facility has certain advantages over earlier known facilities, it has not been entirely satisfactory in terms of energy utilization.

From EP 943 308, a method as well as an arrangement for generating and/or administering temperature an/or mechanical stimuli has become known, in which ice granules are applied to the body of the person to be treated. This method, too, has not met expectations with regard to certain purposes.

Finally, it has become known to introduce ice in buckets into the warm air booth so as to give the guests a chance to rub their bodies with the ice. With this type of application, only breast and legs could be treated, while the back, which would have been most important, remained untreated.

The present invention has as its object to provide measures for avoiding the disadvantages of known facilities and to achieve substantially enhanced treatment results. This object is solved by the characterizing feature of claim 1. As the cold medium, e.g. slight amounts of snow, ice flakes, ice cube granules or the like, can be fed or introduced, resulting in a fluctuating thermal course.

By the measures according to claims 2 and 3, the stimulus effects sought are enhanced.

According to the invention, the facility which serves to carry out the method has the characteristic features according to claim 4.

According to a further characteristic feature of the invention, the device for supplying cold media is arranged in the region of the air circulation means, i.e. of a rotor arranged on the ceiling side.

EP 246 179 A shows a sauna with a snow gun, and DE 201 02 686 U shows a sauna with a supply means for pieces of ice, a crushing means being provided. None of the two documents shows the measure that the device for supplying cold media is arranged in the region of the air circulating means. This allows for a space-saving arrangement.

By the measures according to claim 6, a favorable distribution of the cold medium is achieved.

The measure according to claim 7 serves to protect the guests of the sauna from an unpleasant cold shock.

The measure according to claim 8 characterizes a suitable further development of the warm booth.

The features according to claims 9 and 10 characterize measures for an advantageous operation of the facility according to claim 8.

Exemplary embodiments for a few types of warm air booths will be explained hereinafter. Therein,

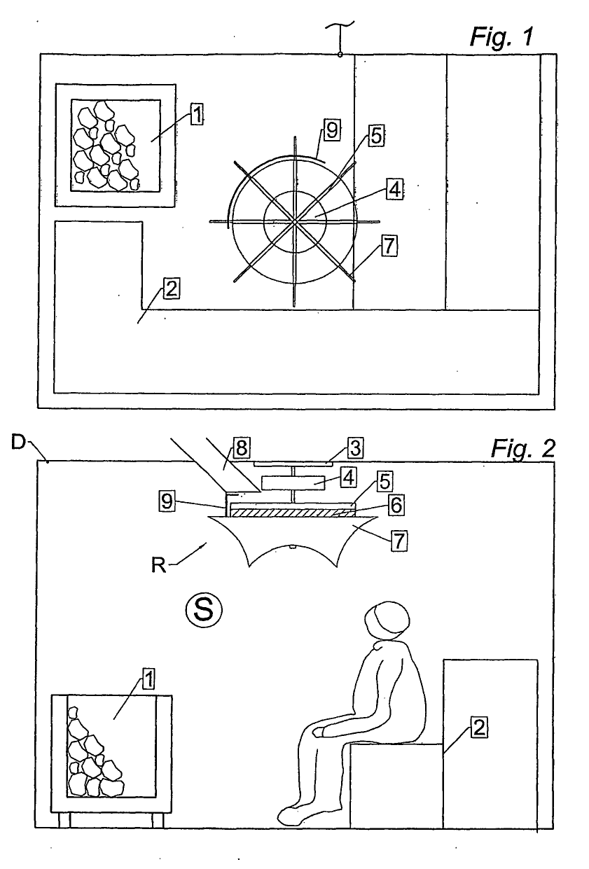

FIGS. 1 and 2 show a sauna booth seen in top view and in side view;

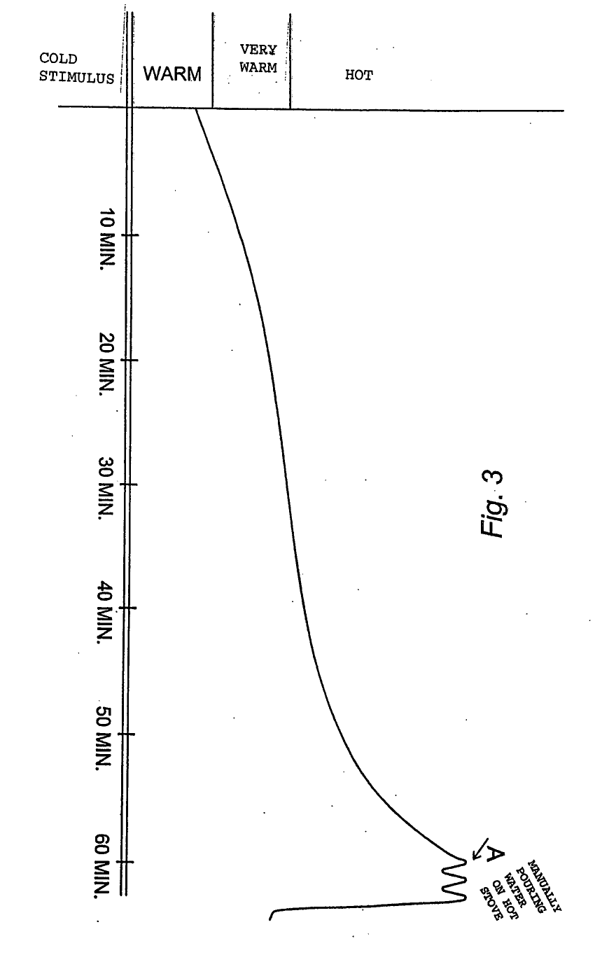

FIG. 3 shows the temperature course of a conventional sauna;

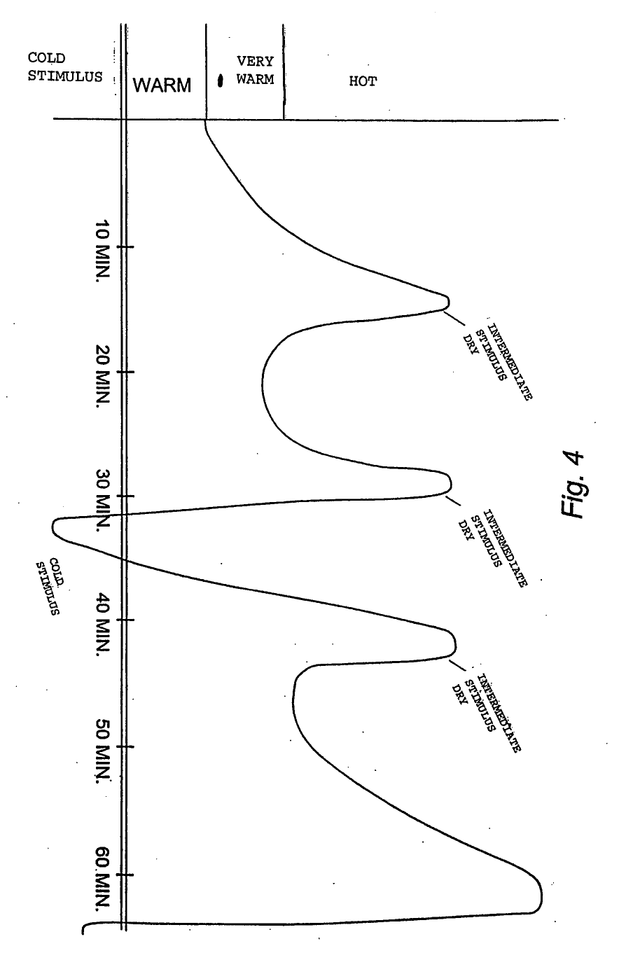

FIG. 4 shows the temperature course of the sauna according to the invention;

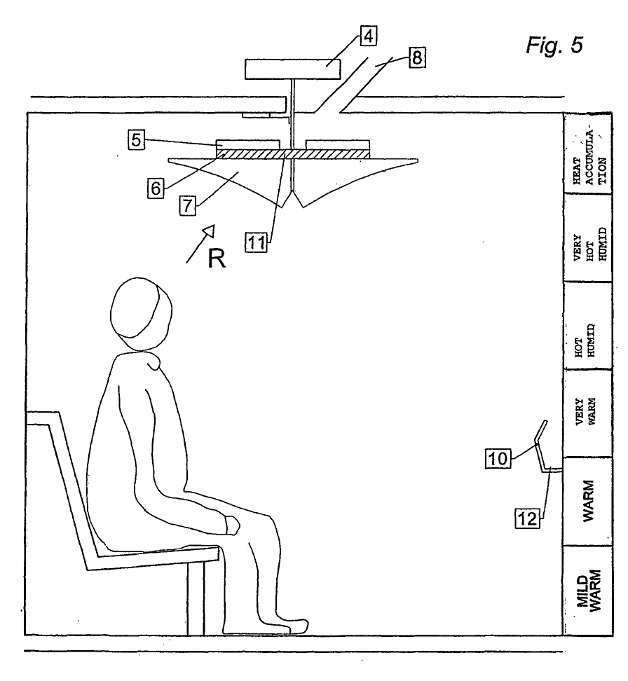

FIG. 5 shows a warm air booth for a steam bath;

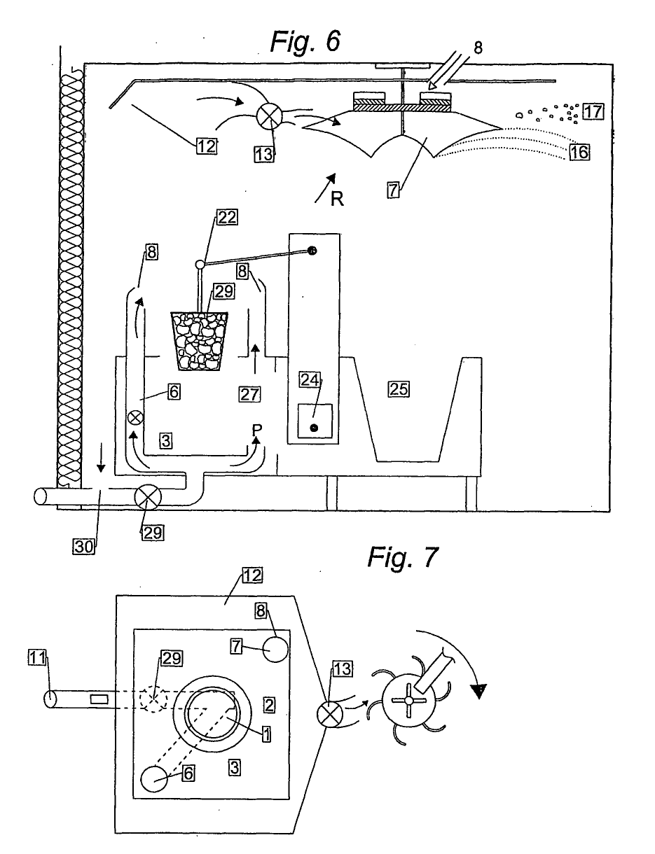

FIGS. 6 to 9 show details of a warm air booth for a stone bath;

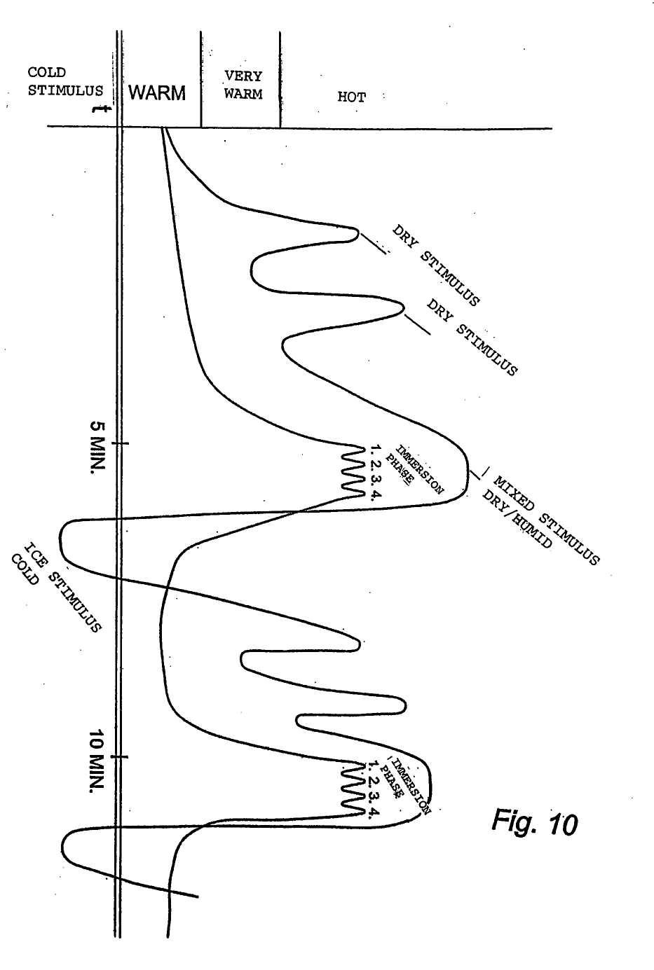

FIG. 10 shows the temperature course in a stone bath;

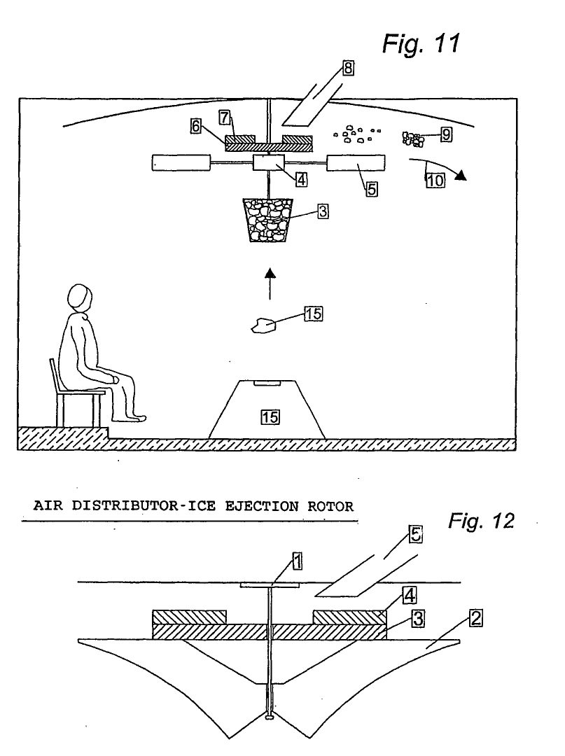

FIG. 11 shows a warm air booth for a so-called Brechel bath; and

FIG. 12 shows a detail of FIG. 11.

In FIGS. 1 and 2, a sauna stove is denoted by 1, a sitting facility for a visiting person by 2, a ceiling-side retention plate for a rotor R by 3, which rotor is driven by a motor 4 and has air lamellae 7 which are covered by an insulating layer 6 on their ceiling side, above which, preferably radially or obliquely outwardly directed ejecting fingers 5′ are located on an ejector disk 5 serving as an ice distributing means. An insertion duct for ice particles is denoted by 8, it being possible by means of a segment ring 9 to shield off the ice ejection area relative to a partial region of the room, particularly where no bathing guests are present, e.g. opposite the entrance door.

After having been turned on, the motor-driven fan R on the ceiling D of the sauna booth S will give rise to a short, very intensive thermal stimulus by convection which forms by the energy delivery of the warm air flowing along the skin. After a short operating time, the fan is turned off again so that the temperature in the sauna booth will return to normal. After a certain period, this procedure will be repeated. During the so-called superheating peak, e.g. when water is poured onto the hot stove, pieces of ice are thrown in through the duct 8, which pieces of ice are hurled into the room together with the hot dry air by the ejecting fingers 5 of the rotor R. This procedure will be repeated a few times.

Whereas during the previous sauna operation, as indicated by the diagram in FIG. 3, there had been a nearly linear thermal increase up to the manual pouring of water on the hot stove at point A, in the course according to the invention, intermediate stages Z are provided between the beginning and the said pouring on of water A, as shown in FIG. 4, which intermediate stages are partially generated by convective hot air, partially by convective hot air and, in addition, during the introduction of the cold medium, e.g. ice granules or snow, and cause a lowering of the temperature from hot to very warm, whereby special stimuli develop in the body of the person treated.

The ice particles or snow flakes blown in have the advantage that during their melting procedure, they will remain longer on the skin of the person treated, and, when being dissolved, will generate humidity that will be mixed, by means of the rotor R, with the air present in the sauna room S.

Preferably, the inner equipment of the sauna booth, in particular the seating accommodations, are made of a material with poor heat conductivity, e.g. glass fiber-synthetic resin (GFSR) which also is moisture-proof. By this, fire protection is achieved.

Within the scope of the invention, optic and/or acoustic signaling devices can be provided in the booth, which will call the attention of the booth users to the forthcoming introduction of the cold medium so as not to cause a shock effect.

Similar to the sauna booth according to FIGS. 1 and 2, the steam bath booth illustrated in FIG. 5 has a rotor R with an impeller 7 having air-distributing lamellae for air circulation, which is covered by an ice ejector disk 5 with ejecting fingers as well as an insulating layer 6 arranged therebelow. The impeller 7 is driven by the motor 4 via the drive shaft 11 which is mounted on the ceiling side in the retention plate 3.

Vapor is introduced via a pipe 10 which is protected by means of a cover 12.

The inventive use of the hot air circulation which, temporarily, is coupled with the introduction of ice particles through the insertion duct 8 allows the bathing guest to experience a superheating peak due to the thermal transmission of the humid-hot air flowing along his/her body. Shortly before its end, ice particles, snow or the like are introduced into the distributing system which will cause an extreme temperature counterpoint. Contact of the particles on the skin will be so short that, if one did not know, one could not realize with certainty whether the stimulus was warm or cold. Thereafter, ice particles possibly present on the seating benches may be manually used for refreshing rubs.

In a stone bath as those shown in FIGS. 6 to 9, stones are put into a basket 21 made of iron or the like and, by means of a pivoting mechanism 22 and by a driving means, introduced into an electric furnace 23 for heating the stones. A driving means for the pivoting mechanism of the stone basket is indicated by 24. Subsequently, the stones in basket 21 are introduced into the oppositely arranged water tank 25 by means of the pivoting mechanism 22, where the stones are quenched so as to develop steam, whereupon the basket 21 is returned into the electric furnace 23 again for an after-heating of the stones.

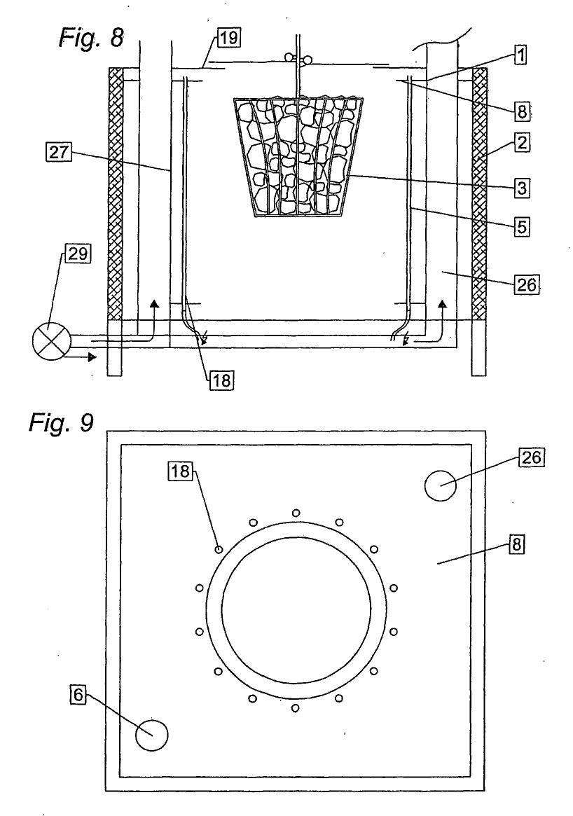

The circulated air for the electric furnace 23 or for another heating means emitting radiation heat is guided to the electric furnace 23 as fresh air through the suction opening 31 and/or in the bottom region as ambient air through the suction opening 30 by means of a motor-driven air fan 29. The air flow may be guided through a pipe 26 which, preferably, is inwardly lined with fire-clay, and/or it may be guided in the direction of arrow P through a pipe 27 which opens into the furnace interior, e.g. via an opening 27′ (FIG. 8). The pipe 26 may project upwards to beyond the electric furnace and, by this portion 20′ which projects upwards beyond the electric furnace, it may serve as a protective device so as to prevent a bathing guest to unwarily reach into the furnace zone, because guests would not assume that such hot air will flow upwards from the furnace. This air flow may be interrupted or throttled by means of a baffle 28, a throttle device, or the like, so as to increase the temperature in the furnace interior.

The basket 21, or the rod 21′ carrying it, respectively, can be provided with a lid 20 which, as shown in FIG. 8, is upwardly pivotable about a small angle and can sealingly abut on the furnace closing wall 19.

The heating rods of the electric furnace are denoted by 18.

Similar as in the operation of a sauna, a rotor R comprising air distributing lamellae 7 is provided on the ceiling side, ice granules, snow or the like being introduced through a duct 8 arranged thereabove on the ceiling side.

In the stone bath, there are no set bathing cycles as in the sauna. The bathing guests come and go as they like. If a bathing guest enters the stone bath at the beginning of the heat-up time, it will take from 4 to 5 minutes until a real thermal stimulus will occur.

After a short waiting period, cold, unused fresh air will be blown into the furnace 23 through the suction means 31 from the outside and/or warm ambient air will be blown through the suction opening 30 in the bottom region by means of the motor-driven fan 29. After having been heated, the air will be guided in the direction of arrow B through the pipe 6, which acts like a heat exchanger, or in open fashion, via the interior of the electric furnace 23, towards the ceiling where it will be mixed with the remaining air. The motor-driven rotor R is switched on and off according to a program. When switching on the rotor R, the air is pressed outwards and downwards along the wall. When the rotor is switched off, the climate in the bathing area will normalize again. When the rotor is switched on again, a peak of warming will occur when the hot stones immerse in the water tank 25. The steam thus forming rushes upwards, whereby the dry and hot air accumulated in the ceiling region will mix with the steam originating from the immersion procedure. Towards the end of the rotor running time, small pieces of ice, snow or the like will be thrown in via the insertion duct 8 in the ceiling of the room, and they will be hurled into the bathing area by the ice distributing disk 5.

In FIG. 6, an additional fan is denoted by 13, which fan will only be present and effective if the fan R is driven by this fan 13 instead of being driven by a motor, which fan 13 will blow the ambient air from the bathing area through a suction socket 13′ to the rotor and to the air distributing lamellae 6, respectively, in the direction of the arrow entered in the drawing.

In FIG. 10, the temperature course which has hitherto occurred in a stone bath is entered in broken lines, and the one occurring according to the method of the invention is entered in full lines.

The four waves at the peak indicate the slight temperature drop between two immersion phases.

Contrary to this treatment method, the wave peaks are formed by periodically switching off the fan. If the temperature rises as far as to the first peak for producing a first dry stimulus, with the rotor switched on, the temperature will decline when the fan has been turned off, so as to rise again to the second peak for the second dry stimulus when being switched on again, whereupon the rotor will be turned off, and the temperature will drop so as then to rise again as far as to the further peak when the rotor is switched on again. Between these two phases, the cold medium, e.g. ice granules, will be introduced so that the temperature—as illustrated—will fall to below a warm zone, whereupon the procedure can possibly be repeated once or several times. The duration of the individual cycle may, e.g., be 5 minutes.

A further variant of the warm air booth according to the invention is shown by FIG. 11, in which a so-called Brechel bath is schematically illustrated, its name being derived from the use of broken, dried flax which is used as a treatment herb. This booth also has a rotor 5 driven by a motor 4 on the ceiling side and having air distributing lamellae 6 which are covered by an ejector disk 5 having ejecting fingers 5′. In the same manner as in the earlier warm or hot air booths, a—preferably slantingly ending—insertion duct 8 is provided above the rotor R, through which duct the cold medium, e.g. ice granules or snow, is introduced. In a way similar to the stone bath, a basket 21 is provided in this bath, yet different from the stone bath, it is not stones but herbs which are introduced and which will be permeated by the vapor of a vapor generator 14. The vapor indicated by a cloud 15 withdraws the active substance from the herbs and introduces it into the air circulation. The bathing guests 16 are seated on treatment places 17 which may be designed in a manner similar to the treatment places of the warm air steam bath booths described earlier.

1. A method for operating a warm or hot air booth by using a cold medium, characterized in that the cold medium is introduced into a flowing warm or hot air at time intervals so as to provide stimuli in the human body.

2. A method according to claim 1, characterized in that the warm or hot air is circulated in a booth on the ceiling side thereof and is calmed at time intervals and supplied with the cold medium.

3. A method according to claim 2, characterized in that the calming of the air is achieved by periodically switching off a fan, and in that a temperature drop caused thereby generates a dry stimulus in the person to be treated, and in that a cold stimulus is generated by the rotor being switched off in between and by a cold medium being introduced.

4. A warm air booth for carrying out the method according to claim 1, characterized in that in addition to the usual heating and air circulating means, a device for supplying cold media is provided which is arranged in the region of the air circulating means.

5. A warm air booth according to claim 4, characterized in that the device for supplying cold media is arranged on the ceiling side, above the air circulating device, e.g. a rotor.

6. A warm air booth according to claim 5, characterized in that the rotor (R) is covered by an ejection disk (5) with outwardly directed, preferably radially and/or slantedly thereto extending ejecting fingers (5).

7. A warm air booth according to claim 6, characterized in that at a location, where no guests are seated, the ejector disk (5) with the ejecting fingers (5′) is shielded off by a segment ring (9).

8. A warm air booth according to at least one of claims 4 to 7, embodied as a stone bath with a heating device preferably designed as an electric furnace which has a fresh air inlet on its bottom side, characterized in that laterally of the furnace wall, at least one pipe 26, channel duct or the like is provided which, preferably, is lined with fire-clay and ends in the booth space at a closing wall (19) of the furnace (23).

9. A warm air booth according to claim 8, characterized in that the pipe (26) projects from the furnace (23) into the booth space and forms a safety means against unauthorized manipulations in the furnace interior.

10. A warm air booth according to any one of claims 8 and 9, characterized in that the fresh air is guided through at least one second pipe (27), duct or the like, which ends e.g. through an opening (27′) or the like.
